(19) United States
(12) Patent Application Publication
(10) Pub. No.: US 2021/0154603 A1
(43) Pub. Date: May 27, 2021

(54) LOGIC FOR CONTROL OF WATER FLOW THROUGH A SCREEN ASSEMBLY

(71) Applicants: TERRY DUPERON, SAGINAW, MI (US); KENNETH BLANCHARD, SANFORD, MI (US); BRYCE FUNCHION, TECUMSEH, MI (US)

(72) Inventors: TERRY DUPERON, SAGINAW, MI (US); KENNETH BLANCHARD, SANFORD, MI (US); BRYCE FUNCHION, TECUMSEH, MI (US)

(21) Appl. No.: 16/953,536

(22) Filed: Nov. 20, 2020

Related U.S. Application Data
(60) Provisional application No. 62/941,243, filed on Nov. 27, 2019.

(51) Int. Cl. B01D 29/64; B01D 29/44; B01D 37/04

(52) U.S. Cl. CPC B01D 29/6484; B01D 37/045; B01D 29/445

(57) ABSTRACT

Logic that is used in water bar screen assemblies to control the flow of water through the assembly.

### BACKGROUND OF THE INVENTION

The instant invention deals with a logic that is used in water bar screen assemblies to control the flow of water through the assembly. Devices useful in the screening of water and the methods used to operate a screen in a water or wastewater stream are known. Such methods are used in a variety of applications including pump stations, fresh and salt water intake systems, storm sewage outfall, combined sewage outfall, wastewater treatment, industrial water and wastewater treatment systems.

Screen types on such systems consist of screening media constructed of perforated panels, slotted panels, bars, wire mesh and other type of such screening media. The trend has been to leave openings in the screen that are smaller and smaller in order to take more debris out of the water.

The screens are typically cleaned using some method to allow more throughput of water. Such methods can be for example, spraying with water, rotating brushes, wiper blades, scrapers, or a combination of these methods.

### THE INVENTION

The instant invention deals with a logic that is used in water bar screen assemblies to control the flow of water through the assembly and to methods therefor.

Thus, this invention deals with a method of controlling the flow of water through a bar screen assembly positioned in the water, the method comprising using the logic of FIG. 1.

This invention also includes as part of the invention, a bar screen water assembly similar to that found in FIG. 2, wherein the bar screen water assembly is relatively consistent with the bar screen assembly found in U.S. Pat. No. 5,425,875, that issued Jun. 20, 1995 to Terry Duperon.

Another embodiment of this invention is logic for controlling a water screen assembly, said logic following a flow chart as set forth in FIG. 1.

### BRIEF DESCRIPTION OF THE DRAWINGS

FIG. 1 is a flow diagram of the logic used in the instant invention.

FIG. 2 is water screening assembly found in U.S. Pat. No. 5,425,875. (PRIOR ART)

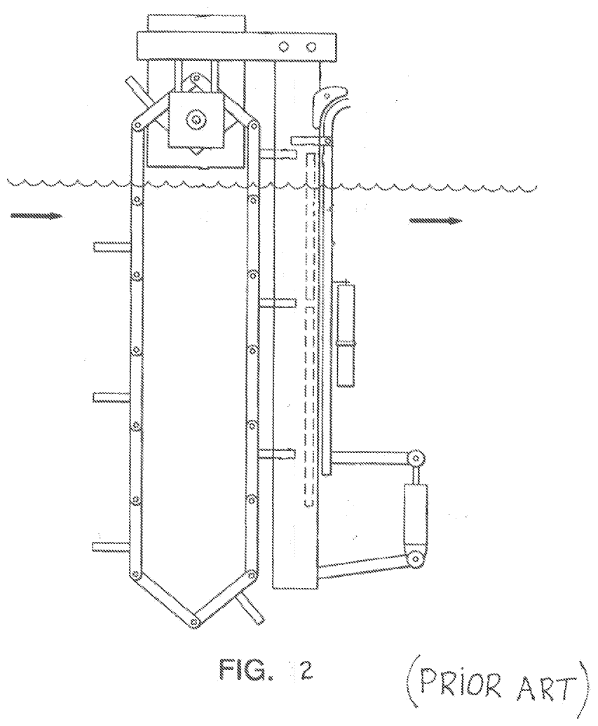

### DETAILED DESCRIPTION OF THE INVENTION

The detailed description of the instant invention can best be understood with regard to an understanding of the apparatus described in the aforementioned U.S. patent that is equipped with a vertical bar screen apparatus.

The essence of the instant invention is the use of a specific logic to control the bar screen activity wherein, the logic has the ability to control the lifting of a certain number of the bars of the bar screen, and the ability to control the amount of opening left by the vacant bars by closing the certain lifted bars to specific opening size. The control of these openings is ultimately controlled by the head differential of the water flowing through the screen. When a head differential above the screen is high relative to the level of the water below the screen, the control can regulate the openings to level out the flow of water.

Thus, there is an upstream water level detector (sensor) which detects the water flow level upstream of a screen apparatus and a downstream water level detector which detects the water flow level downstream of the screen, along with a blockage determination unit which determines a percentage screen blockage of the screen based on the water flow level upstream of the screen and the water flow level downstream of the screen. The flow rate is determined by the Bernoulli equation for open channel flow rate.

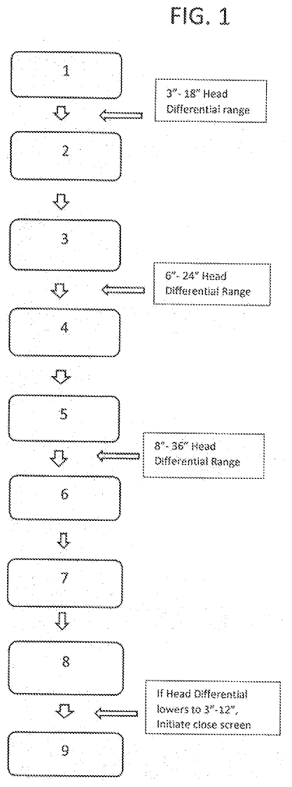

Turning now to FIG. 1, which is a schematic of a flow diagram illustrating the logic used in the instant invention, there is shown Box 1 detecting an increase in the head differential through screen blockage or increased flow rate of water. For purposes of this invention there is a head differential range of 3 to 18 inches within which the control operates.

Box 2 operates to increase the speed of the scrapers or wipers on the screen to remove debris blockage while Box 3 operates to monitor and sensed continued increase in the head differential. For purposes of this invention, at this stage, the head differential range operates in about the 6 to 24 inch range.

Box 4 illustrates the apparatus scrapers increase speed, even to maximum speed if required to attempt to clear the apparatus to increase the flow of water and achieve the desired level of head differential that can be achieved. At this point, the head differential range is about 8 to 36 inches.

Failing to achieve the desired level of head differential Box 6 opens the screen by elevating a specific number of bars (even 100% of them) out of the forward flow of the water, which lowers the head differential/upstream water level (Box 7). At this point, if the head differential is lowered to a range of about 3 inches to 12 inches, the screen is closed (Box 8).

The last operation is to use the alternate closing method of this invention (Box 9) of stopping the raised screen from closing all of the way. The amount of opening that can be left is determined by how far the head differential is out of range and typically, and sometimes, only certain of the vertical bars are used to do this operation. For purposes of this invention, this is done desirably, sequentially, but not necessarily so. This maneuver allows scrapers to pass over the bars of the screen and clean the screen.

What is claimed is:

1. A method of controlling the flow of water through a bar screen assembly positioned in said water, said method comprising using the logic of the flow diagram in FIG. 1.

2. A bar screen water assembly controlled by the logic in FIG. 1.

3. Logic for controlling a water screen assembly, said logic following the flow diagram of FIG. 1.
